(19) United States
(12) Patent Application Publication
(10) Pub. No.: US 2026/0288234 A1
(43) Pub. Date: Sep. 24, 2026

(54) TECHNIQUES FOR ALWAYS-ON EYE TRACKING

(71) Applicant: NVIDIA CORPORATION, Santa Clara, CA (US)

(72) Inventors: Jason Lavar CLEMONS, Leander, TX (US); Muya CHANG, Bellevue, WA (US); Steve DAI, Union City, CA (US); Subhash GUTTI, Milpitas, CA (US); Shalini DE MELLO, San Francisco, CA (US); Seonwook PARK, Santa Clara, CA (US); Sujata SHARMA, Austin, TX (US)

(21) Appl. No.: 19/088,787

(22) Filed: Mar. 24, 2025

(51) Int. Cl. G06F 3/01; A63F 13/213; G06T 7/73; G06V 10/24; G06V 10/25; G06V 10/70; G06V 40/16

(52) U.S. Cl. CPC G06F 3/013; A63F 13/213; G06T 7/73; G06V 10/247; G06V 10/25; G06V 10/70; G06V 40/161; G06V 40/168; G06V 40/172; G06T 2207/20081; G06T 2207/30201

(57) ABSTRACT

The disclosed method for eye tracking includes processing an image using a trained machine learning model that detects a face within the image and predicts an identity of the face, determining at least one of an eye gaze or a point of regard based on the face and the identity of the face, and performing, via a computing device, at least one action based on the at least one of the eye gaze or the point of regard.

### BACKGROUND

### Technical Field

Embodiments of the present disclosure relate generally to computer science, computer vision, artificial intelligence, and machine learning, and more specifically, to techniques for always-on eye tracking.

### Description of the Related Art

Eye tracking technologies use computer vision and artificial intelligence (AI) to determine where a user is looking by analyzing eye movements of the user. Eye tracking typically uses one or more cameras to capture the position and movement of the eyes, which can be analyzed to identify the direction of gaze and a point on which the user is focusing. For example, the point of regard, which is a point where the eye gaze meets the plane of a screen, could be computed. Eye tracking is useful in many areas, such as improving user interactions with computers, enhancing virtual and augmented reality experiences, and enabling hands-free control of devices.

One conventional approach for eye tracking uses a pipeline that includes multiple stages of analysis. For example, the eye-tracking pipeline could include stages such as detecting a face, determining the locations of landmarks on the face, estimating a head pose, detecting the eyes, determining the center point of the pupils, and calculating an eye gaze direction. The eye-tracking pipeline could also include a stage of identifying a user. The stages can be implemented using different image processing techniques. For example, one machine learning model could be used to detect a face, another machine learning model could be used to determine the locations of landmarks on the face, another machine learning model could be used to determine a gaze direction, and yet another machine learning model could be used to identify a user.

One drawback of the above approach, however, is the multiple stages of the eye-tracking pipeline, such as the different machine learning models that need to be executed, typically require significant computational resources and consume a large amount of power to execute. Accordingly, the eye-tracking pipeline is unsuitable for scenarios in which the computational resources or available power are limited. For example, when a laptop computer is in a low power sleep mode, that laptop computer may lack the computational resources and power required to execute a conventional eye-tracking pipeline at an acceptable rate. As another example, when a computer is running a video game at the highest settings, that computer may not have additional computational resources and power to execute a conventional eye-tracking pipeline.

As the foregoing illustrates, what is needed in the art are more efficient techniques for eye tracking.

### SUMMARY

One embodiment of the present disclosure sets forth a computer-implemented method for eye tracking. The method includes processing an image using a trained machine learning model that detects a face within the image and predicts an identity of the face. The method further includes determining at least one of an eye gaze or a point of regard based on the face and the identity of the face. In addition, the method includes performing, via a computing device, at least one action based on the at least one of the eye gaze or the point of regard.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, an eye-tracking pipeline can be executed using significantly less computational resources and power than conventional eye-tracking pipelines require. The disclosed techniques can also compute a point of regard with relatively low latency and a relatively high frame rate of, for example, up to 120 Hz. In addition, the disclosed techniques can process input images that are captured by ordinary cameras, such as the integrated cameras that are built into laptop computers, as opposed to specialized cameras such as infrared cameras. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the machine learning server of FIG. 1, according to various embodiments;

FIG. 3 is a more detailed illustration of the computing device of FIG. 1, according to various embodiments;

FIG. 4 is a block diagram illustrating an exemplar cloud computing system, according to various embodiments;

FIG. 5 is a more detailed illustration of the computer vision application of FIG. 1, according to various embodiments;

FIG. 6 is a more detailed illustration of the self-attention module of FIG. 5, according to various embodiments;

FIG. 7 is a flow diagram of method steps for training the single-stage detection and identification model of FIG. 1, according to various embodiments; and

FIG. 8 is a flow diagram of method steps for determining a point of regard from an input image, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for always-on eye tracking. In some embodiments, a computer-vision (CV) application receives as input an image, such as a frame of a video that is captured by a camera, and the CV application processes the input image to determine a point of regard, which is where an eye gaze meets the plane of a screen. First, the CV application downscales the input image to generate a downscaled image. The CV application processes the downscaled image using a trained single-stage detection and identification model to generate face bounding box(es) and associated confidence score(s), facial key points, and signature(s) indicating identities of face(s) within the downscaled image. The single-stage detection and identification model can be optimized using a hybrid per-vector scaled quantization based on the capabilities of the hardware and a target performance in terms of latency, accuracy, and/or energy. In addition, complex activations in the single-stage detection and identification model, such as SiLU (sigmoid linear unit) activations, can be replaced with hardware-friendly nonlinear functions, such as ReLU (rectified linear unit) activations. If the single-stage detection and identification model detects multiple faces, then the CV application selects one of the faces associated with a bounding box, facial key points, and signature to use. Although described herein primarily with respect to selecting one face as a reference example, in some embodiments, multiple faces can be processed, and gaze detection can be performed on each of the multiple faces, such as the top-k faces that are detected. For a selected face, the CV application computes a head pose, using facial key points associated with the selected face. Then, the CV application generates a normalized image of an eye region of the selected face, or the entire face, based on the head pose, the facial key points, and the input image. In some embodiments, the normalized image of the eye or face region can be generated using a warp perspective that is quantized. The CV application processes the normalized image of the eye or face region using a trained gaze estimation model to determine gaze angles. Similar to the single-stage detection and identification model, the gaze estimation model can be optimized using a hybrid per-vector scaled quantization and/or complex activations in the gaze estimation model, such as SiLU activations, can be replaced with hardware-friendly nonlinear functions, such as ReLU activations. In some embodiments, the gaze estimation model includes a self-attention that is optimized to better support the hybrid per-vector scaled quantization. In some embodiments, the gaze estimation model is trained specifically for a user, using a calibration procedure to improve accuracy. The CV application computes a point of regard based on the gaze angles output by the gaze estimation model, the head pose, and the facial key points.

The techniques for always-on eye tracking have many real-world applications. For example, those techniques could be applied to determine a point of regard for user presence detection, such as user presence detection that is used to wake up a computing device or screen thereof from a sleep mode and/or switch the computing device or the screen into the sleep mode when no user is looking at the screen. As another example, those techniques could be applied to determine a point of regard for gaze-aware gaming. As a further example, those techniques could be applied to determine a point of regard for authenticating a user. As yet another example, those techniques could be applied to determine a point of regard for safety monitoring.

The above examples are not in any way intended to be limiting. As persons skilled in the art will appreciate, as a general matter, the techniques for always-on eye tracking can be implemented in any suitable application.

### System Overview

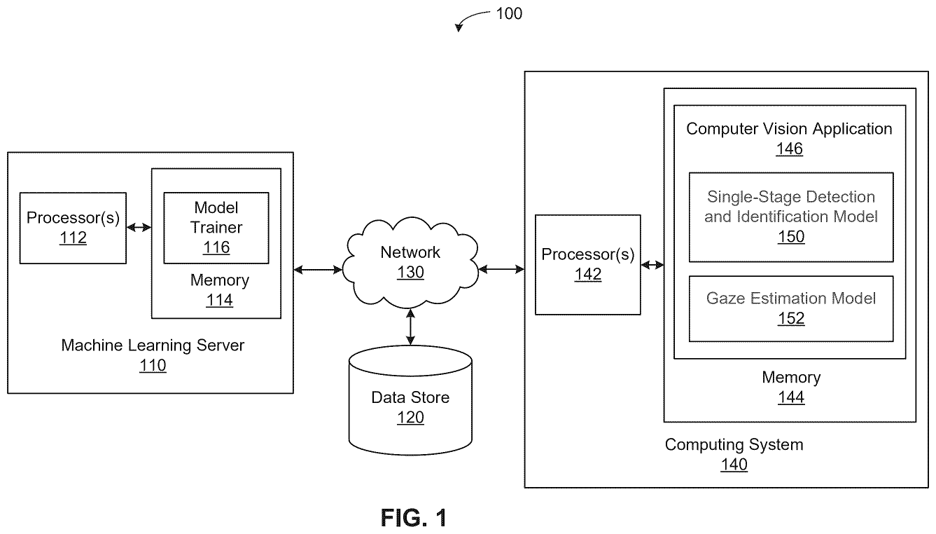

FIG. 1 illustrates a block diagram of a computer-based system 100 configured to implement one or more aspects of at least one embodiment. As shown, the system 100 includes, without limitation, a machine learning server 110, a data store 120, and a computing device 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor(s) 112 receive user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

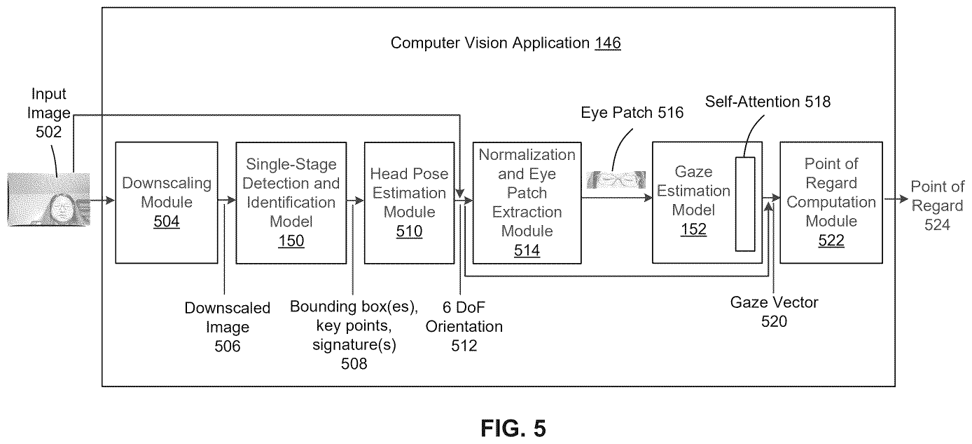

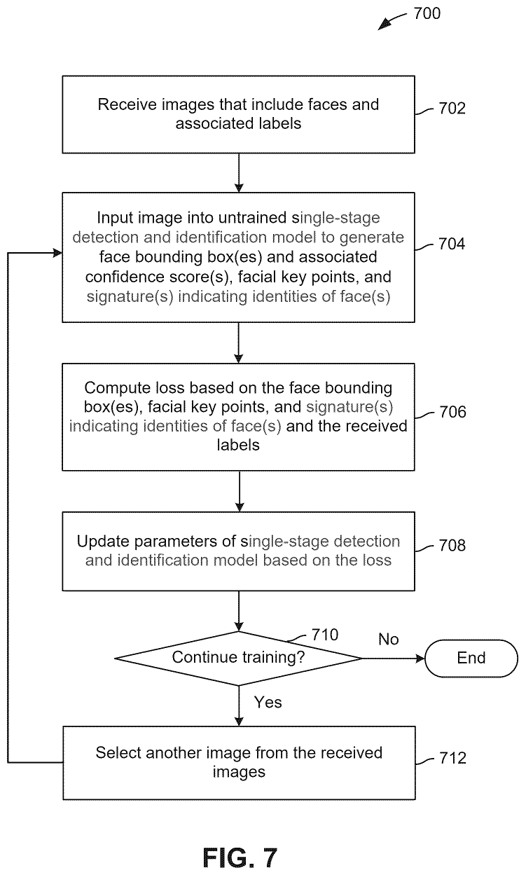

In some embodiments, the model trainer 116 is configured to train one or more machine learning models, including a single-stage detection and identification model 150 that is trained to detect and identify faces in images and/or a gaze estimation model 152 that is trained to predict eye gaze. Techniques for training the single-stage detection and identification model 150 are discussed in greater detail below in conjunction with FIGS. 5 and 7. Training data and/or trained machine learning models, including the single-stage detection and identification model 150 and/or the gaze estimation model 152, can be stored in the data store 120, or elsewhere. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

As shown, a computer vision (CV) application 146 that includes the trained single-stage detection and identification model 150 and the trained gaze estimation model 152 is stored in a memory 144, and executes on processor(s) 142, of the computing device 140. The memory 144 and the processor(s) 142 may be similar to the memory 114 and the processor(s) 112, respectively, of the machine learning server, described above. In some embodiments, the CV application 146 can be any technically feasible application that uses the trained single-stage detection and identification model 150 and the trained gaze estimation model 152 for point of regard detection. For example, the CV application 146 could be an application that determines a point of regard for user presence detection (e.g., in order to wake up a computing device of screen thereof from a sleep mode or switch the computing device or screen to the sleep mode when no user is looking at the screen), for gaze-aware gaming in which in-game assistance is provided based on the point of regard, for authenticating a user, for safety monitoring, and/or the like. The CV application 146 is discussed in greater detail below in conjunction with FIGS. 5-6 and 8.

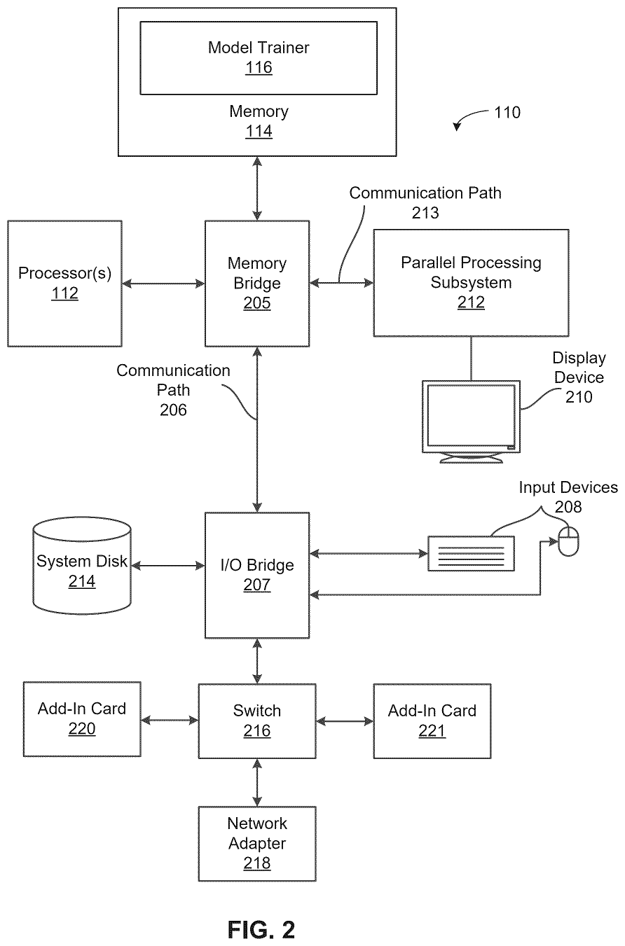

FIG. 2 is a block diagram illustrating the machine learning server 110 of FIG. 1 in greater detail, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network. In some embodiments, the machine learning server 110 can include one or more similar components as the machine learning server 110.

In various embodiments, the machine learning server 110 includes, without limitation, the processor(s) 112 and the memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or re-movable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor(s) 112 and other connection circuitry on a single chip to form a system on a chip (SoC).

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor(s) 112. In other embodiments, parallel processing subsystem 212 may be connected to I/O bridge 207 or directly to processor(s) 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized re-sources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

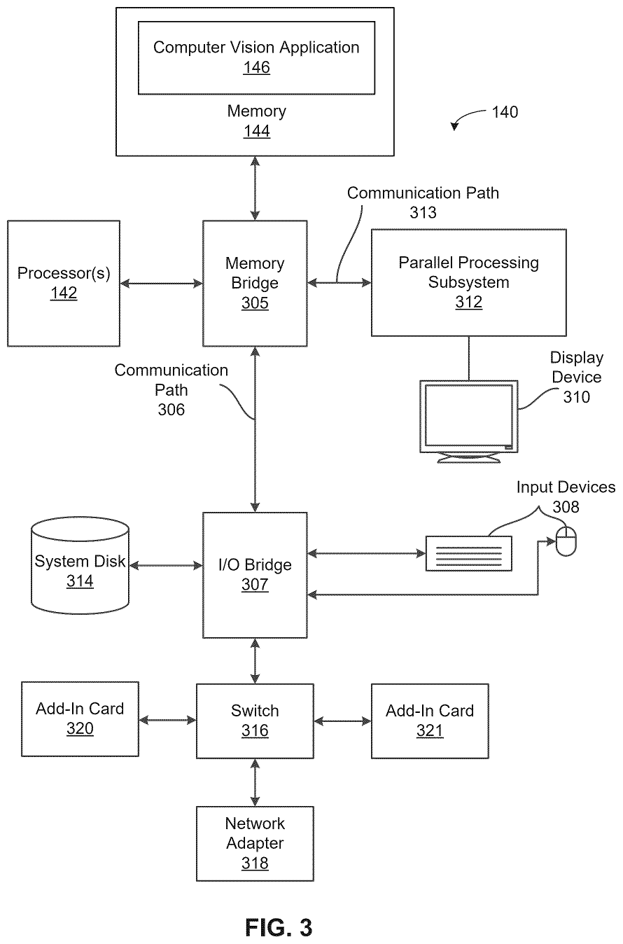

FIG. 3 is a block diagram illustrating the computing device 140 of FIG. 1 in greater detail, according to various embodiments. The computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing device 140 is a server machine operating in a data center or a cloud computing environment that provides scalable computing resources as a service over a network. In some embodiments, the machine learning server 110 can include one or more similar components as the computing device 140.

In various embodiments, the computing device 140 includes, without limitation, the processor(s) 142 and the memory(ies) 144 coupled to a parallel processing subsystem 312 via a memory bridge 305 and a communication path 313. Memory bridge 305 is further coupled to an I/O (input/output) bridge 307 via a communication path 306, and I/O bridge 307 is, in turn, coupled to a switch 316.

In one embodiment, I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, computing device 140 may not include input devices 308, but may receive equivalent input information by receiving commands (e.g., responsive to one or more inputs from a remote computing device) in the form of messages transmitted over a network and received via the network adapter 318. In some embodiments, switch 316 is configured to provide connections between I/O bridge 307 and other components of the computing device 140, such as a network adapter 318 and various add-in cards 320 and 321.

In some embodiments, I/O bridge 307 is coupled to a system disk 314 that may be configured to store content and applications and data for use by processor(s) 142 and parallel processing subsystem 312. In one embodiment, system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 307 as well.

In various embodiments, memory bridge 305 may be a Northbridge chip, and I/O bridge 307 may be a Southbridge chip. In addition, communication paths 306 and 313, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and/or compute processing operations. System memory 144 includes at least one device driver configured to manage the processing operations of the one or more PPUs within parallel processing subsystem 312. In addition, the system memory 144 includes the CV application 146. Although described herein primarily with respect to the CV application 146, techniques disclosed herein can also be implemented, either entirely or in part, in other software and/or hardware, such as in the parallel processing sub-system 312.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, the processor(s) 142 issues commands that control the operation of PPUs. In some embodiments, communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 312, may be modified as desired. For example, in some embodiments, system memory 144 could be connected to the processor(s) 142 directly rather than through memory bridge 305, and other devices may communicate with system memory 144 via memory bridge 305 and processor 142. In other embodiments, parallel processing subsystem 312 may be connected to I/O bridge 307 or directly to processor 142, rather than to memory bridge 305. In still other embodiments, I/O bridge 307 and memory bridge 305 may be integrated into a single chip instead of existing as one or more discrete devices. In certain embodiments, one or more components shown in FIG. 3 may not be present. For example, switch 316 could be eliminated, and network adapter 318 and add-in cards 320, 321 would connect directly to I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in at least one embodiment. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

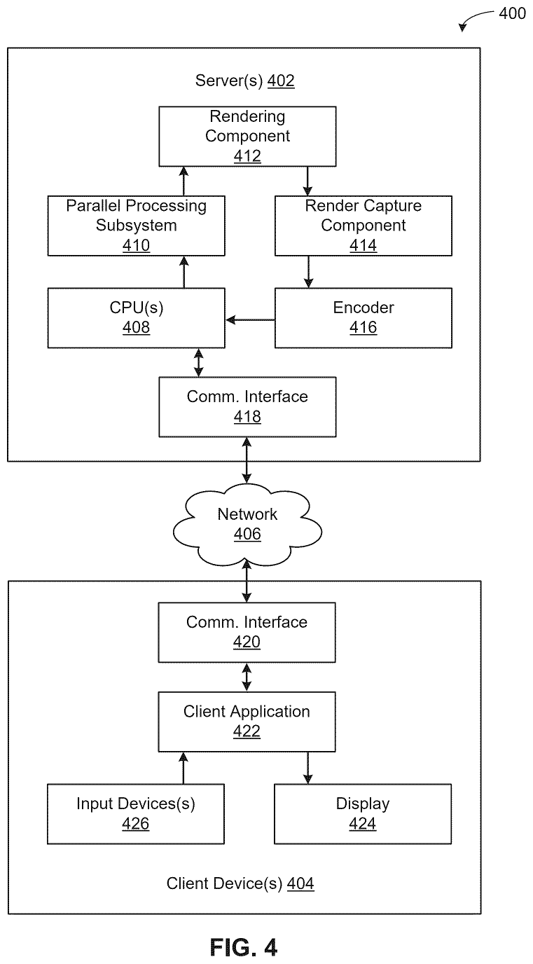

FIG. 4 is a block diagram illustrating an exemplar cloud computing system, according to various embodiments. As shown, a computing system 400 includes server(s) 402 that are in communication with client device(s) 404 via network(s) 406. Each of the server(s) 402 may include similar components, features, and/or functionality as the exemplary computer system 100, described above in conjunction with FIG. 1-3. Each of the server(s) 402 may be any technically feasible type of computer system, including, without limitation, a server machine or a server platform. Each of the client devices(s) 404 may also include similar components, features, and/or functionality as the computer system 100, except each client device 404 executes a client application 422. Each of the client device(s) 404 may be any technically feasible type of computer system including, without limitation, a desktop machine, a laptop machine, a hand-held/mobile device, and/or a wearable device. In some embodiments, one or more of the server(s) 402 and/or the client device(s) 404 may be replaced with virtualized processing environment(s), such as virtualized processing environment(s) provided by one or more VMs and/or containers that execute on underlying hardware system(s). The network(s) 406 may include any type of network(s), such as one or more local area networks (LANs) and/or wide area networks (WANs) (e.g., the Internet).

In some embodiments, the server(s) 402 may be included in a cloud computing system, such a public cloud, a private cloud, or a hybrid cloud, and/or in a distributed system. For example, the server(s) 402 could implement a cloud-based gaming platform that provides a game streaming service, also sometimes referred to as “cloud gaming,” “gaming on demand,” or “gaming-as-a-service.” In such a case, games that are stored and executed on the server(s) 402 are streamed as videos to the client device(s) 404 via client application(s) 422 running thereon. During game sessions, the client application(s) 422 handle user inputs and transmit those inputs to the server(s) 402 for in-game execution. Although cloud-based gaming platforms are described herein as a reference example, persons skilled in the art will appreciate that, as a general matter, the server(s) 402 may execute any technically feasible types of application(s), such as the design applications described above.

As shown, each of the client device(s) 404 includes input device(s) 426, the client application 422, a communication interface 420, and a display 424. The input device(s) 426 may include any type of device(s) for receiving user input, such as a keyboard, a mouse, a joystick, and/or a game controller. The client application 422 receives input data in response to user inputs at the input device(s) 426, transmits the input data to one of the server(s) 402 via the communication interface 420 (e.g., a network interface controller) and over the network(s) 406 (e.g., the Internet), receives encoded display data from the server 402, and decodes and causes the display data to be displayed on the display 424 (e.g., a cathode ray tube, liquid crystal display, light-emitting diode display, or the like). As such, more computationally in-tense computing and processing can be offloaded to the server(s) 402. For example, a game session could be streamed to the client device(s) 404 from the server(s) 402, thereby reducing the requirements of the client device(s) 404 for graphics processing and rendering.

As shown, each of the server(s) 402 includes a communication interface 418, CPU(s) 408, a parallel processing subsystem 410, a rendering component 412, a render capture component 414, and an encoder 416. Input data transmitted by the client device 404 to one of the server(s) 402 is received via the communication interface 418 (e.g., a network interface controller) and processed via the CPU(s) 408 and/or the parallel processing subsystem 410 included in that server 402. In some embodiments, the CPU(s) 408 may receive the input data, process the input data, and transmit data to the parallel processing subsystem 410. In turn, the parallel processing subsystem 410 renders one or more standalone images and/or image frames, such as the frames of a video game, based on the transmitted data.

Illustratively, the rendering component 412 employs the parallel processing subsystem 410 to render the result of processing the input data, and the render capture component 414 captures the rendering as display data (e.g., as image data capturing standalone image(s) and/or image frame(s)). The rendering performed by the rendering component 412 may include ray- or path-traced lighting and/or shadow effects, computed using one or more parallel processing units—such as GPUs, which may further employ the use of one or more dedicated hardware accelerators or processing cores to perform ray or path-tracing techniques—of the server 402. In some embodiments, the rendering component 412 performs rendering using the ray cone tracing techniques disclosed herein. Thereafter, the encoder 416 encodes display data capturing the rendering to generate encoded display data that is transmitted, over the network(s) 406 via the communication interface 418, to the client device(s) 404 for display to user(s).

Returning to the example of cloud gaming, during a game session, input data that is received by one of the server(s) 402 may be representative of movement of a character of the user in a game, firing a weapon, reloading, passing a ball, turning a vehicle, etc. In such a case, the rendering component 412 may generate a rendering of the game session that is representative of the result of the input data, and the render capture component 414 may capture the rendering of the game session as display data (e.g., as image data capturing rendered frames of the game session). Parallel processing (e.g., GPU) resources may be dedicated to each game session, or resource scheduling techniques may be employed to share parallel processing resources across multiple game sessions. In addition, the game session may be rendered using the ray cone tracing techniques disclosed herein. The rendered game session may then be encoded, by the encoder 416, to generate encoded display data that is transmitted over the network(s) 406 to one of the client device(s) 404 for decoding and output via the display 424 of that client device 404.

### Always-On Eye Tracking

FIG. 5 is a more detailed illustration of the CV application 146 of FIG. 1, according to various embodiments. As shown, the CV application 146 includes, without limitation, a downscaling module 504, the single-stage detection and identification model 150, a head pose estimation module 510, a normalization and eye patch extraction module 514, the gaze estimation model 152, and a point of regard computation module 522. The gaze estimation model 152 includes, without limitation, a self-attention module 518.

In operation, the CV application 146 can receive an input image 502, such as a frame of a video that is captured by a camera. The camera can be an ordinary camera, such as an integrated camera that is built into a laptop computer, as opposed to a specialized camera, such as an infrared camera. The CV application 146 processes the input image 502 as follows to determine a point of regard 524, which is where the gaze of a face within the input image 502 meets the plane of a screen. First, the downscaling module 504 downscales the input image 502 to generate a downscaled image 506. In some embodiments, the CV application 146 can also perform pre-processing to de-Bayer image data from the camera sensor and perform a gamma correction to create images that include a grayscale luma component of the image data and are in a quantized format (e.g., 8 bit). The CV application 146 processes the downscaled image 506 using the single-stage detection and identification model 150 to generate face bounding box(es), key points, and signature(s) indicating identities of face(s) 508 within the downscaled image 506. In some embodiments, the single-stage detection and identification model 150 can also output confidence score(s) indicating confidence(s) that the bounding box(es) include faces. If multiple faces are detected, then the CV application 146 selects one of the faces associated with a bounding box, key points, and signature to use. The CV application 146 can select the face to use in any technically feasible manner in some embodiments, such as always selecting a face associated with a largest bounding box, selecting a face closest to a center of the downscaled image 506, selecting a face based on user input or some other criteria, or the like. Although described herein primarily with respect to selecting one face as a reference example, in some embodiments, multiple faces can be processed, and gaze detection can be repeated for each of the multiple faces, such as the top-k faces that are detected. The remaining processing pipeline is performed for the selected face (or repeatedly for multiple faces). More specifically, the head pose estimation module 510 computes a head pose, shown as a 6 degree of freedom (DoF) orientation 512, using key points associated with the selected face. The normalization and eye patch extraction module 514 generates a normalized image of an eye region of the selected face (shown as normalized eye patch 516) or a normalized image of the entire face, based on the 6 DoF orientation 512, the detected facial key points, and the input image. The CV application 146 processes the normalized eye patch 516 (or the normalized face) using the gaze estimation model 152 that can be customized based on the facial identity to determine gaze angles, shown as gaze vector 520. Then, the point of regard computation module 522 computes a point of regard 524 based on the gaze vector 520, the 6 DoF orientation 512 of the head pose, and the facial key points. Due to the use of a one single-stage detection and identification model 150, as well as using a gaze estimation model 152 that includes self-attention layers (self-attention 518) and personalized to each subject based on the signature corresponding to identities of the face, the sizes of the single-stage detection and identification model 150 and the gaze estimation model 152, quantization, and (optionally) hardware acceleration, points of regard can be computed from input images using relatively little computational resources (e.g., only 3 Mb of always-on memory) and average power (e.g., less than 1.5 mW), with relatively low latency and relatively high accuracy, and at a frame rate of up to 120 Hz in some embodiments. Although described herein primarily with respect to point of regard as a reference example, in some embodiments, techniques disclosed herein can be applied for eye tracking more generally, such as to track the eye gaze of a user without computing a point of regard.

The downscaling module 504 takes as input an image 502, such as a frame of a video captured by a camera, and the downscaling module 504 downscales the input image 502 to generate a downscaled image 506. The input image 502 can be downscaled by any amount and in any technically feasible manner, including via known downscaling techniques, in some embodiments. In some embodiments, the amount of downscaling can be based on a desired accuracy of the point of regard that is being determined and/or an amount of available compute resources for executing the computer vision application 146. For example, in some embodiments, the downscaling module 504 can scale the input image from a size of 640×480 pixels to the downscaled image 506 that has a size of 192×192 pixels. In some embodiments, to minimize energy consumption, the input image 502 that the downscaling module 504 receives can be generated by an image signal processor (ISP) that performs a relatively minimal amount of processing on raw sensor data from a camera. In such cases, the input image 502 can include largely raw sensor data with artifacts. In some embodiments, the CV application 146 can also perform pre-processing to de-Bayer image data from the camera sensor and perform a gamma correction to create luma images that are in grayscale and a quantized format (e.g., 8 bit).

The single-stage detection and identification model 150 is a machine learning model that is trained to take as input the downscaled image 506 and to output one or more bounding boxes surrounding one or more faces in the downscaled image 506, key points that are facial fiducials for face tracking, and signatures corresponding to identities of the face(s). In some embodiments, the single-stage detection and identification model 150 can also output confidence score(s) indicating confidence(s) that the bounding box(es) include faces. For example, in some embodiments, the single-stage detection and identification model 150 could output, for each detected face, a bounding box around the face and associated confidence score, five facial key points, and a facial identifier (ID) signature that is a vector or array of numbers unique to the face of a particular individual. In some embodiments, the vector or array can be of a relatively short length (e.g., 32 or 64), as opposed to conventional signatures that oftentimes have a length of 512. The facial ID signature is useful for customizing the gaze estimation model 152 for a face associated with the signature, as described in greater detail below, so that more accurate points of regard can be determined. In some embodiments, the single-stage detection and identification model 150 can be implemented as a trained artificial neural network that includes a number of layers of neurons. Notably, the single-stage detection and identification model 150 is used for both face detection and identification, which can save computational resources and power relative to conventional eye tracking pipelines that use separate machine learning models for face detection and identification.

In order to operate with less power, in some embodiments, the single-stage detection and identification model 150 can also be implemented as a neural network with a small architecture that includes relatively few weights (e.g., a YOLOv5 (You Only Look Once, version 5) network with a small ShuffleNet architecture that includes 500k weights). In some embodiments, the single-stage detection and identification model 150 can be quantized. In some embodiments, the quantization configuration (e.g., bitwidth, scaling mode) of each layer in the single-stage detection and identification model 150 can be based on the capabilities of the hardware and target performance in terms of latency, accuracy, and/or energy. For example, in some embodiments, the single-stage detection and identification model 150 can be optimized using hybrid 4-bit/8-bit per-vector scaled quantization. In some embodiments, the quantization can store weights of layers of the identification model 150 in a lower precision format where each value is represented using only 4 or 8 bits of information, reducing memory usage and saving power. In addition or alternatively, in some embodiments, the quantization can represent activations that are input into the layers or output by the layers using only 4 or 8 bits of information. The quantization can be performed by hardware and/or software in some embodiments. In some embodiments, some layers of the single-stage detection and identification model 150 can be quantized using 8-bit quantization, while other layers of the single-stage detection and identification model 150 can be quantized using 4-bit quantization. For example, early layers and depthwise convolution layers of the single-stage detection and identification model 150 could be quantized using 8-bit quantization to maintain accuracy, while other layers of the single-stage detection and identification model 150 could be quantized using 4-bit quantization to further reduce memory usage and save power. As described, in some embodiments, the quantization performed can be a hybrid per-vector scaled quantization, in which vectors are quantized (reduced to a smaller set of possible values) while applying a scaling factor to each individual vector. Although described herein primarily with respect to 4-bit/8-bit quantization as a reference example, in some embodiments, any suitable quantization can be performed using one or more different quantization formats. In some embodiments, some nonlinear layers can be quantized as well as linear layers. In some embodiments, complex activations in the single-stage detection and identification model 150, such as SiLU (sigmoid linear unit) activations, can be replaced with hardware-friendly nonlinear functions, such as ReLU (rectified linear unit) activations that do not output negative values. In some embodiments, to further save power, only memory that is required to execute each model may be kept active while the model is executing.

In some embodiments, the model trainer 116 can train the single-stage detection and identification model 150 using training data that includes images of faces and associated labels including bounding boxes around the faces, facial key points, and signatures of the faces. For each image in the training data, the model trainer 116 inputs the image into an untrained version of the single-stage detection and identification model 150 to generate bounding box(es) around fac(es) and associated confidence score(s), key points of the face(s), and signature(s) indicating identities of face(s) within the image. The model trainer 116 computes a loss based on the bounding box(es), the key points, and the signature(s) for the image and the received labels for the image. In some embodiments, the loss includes (1) a bounding box loss that is computed as a difference between the bounding box(es) output by the model being trained and the ground-truth bounding box(es) in the training data labels, (2) a classification loss that penalizes misidentifications of faces by the model, (3) an ID loss that is computed as a difference (e.g., a L1 or L2 distance) between the signature(s) output by the model and ground-truth signatures in the training data labels, and (4) an L2 loss between positions of the facial key points output by the model and ground truth facial key points. The model trainer 116 updates parameters of the single-stage detection and identification model 150 based on the loss via, for example, backpropagation with gradient descent or a variation thereof, until a stopping condition is met, such as training has been performed for a predefined number of iterations, the loss plateaus, or the like.

The head pose estimation module 510 takes as input the facial key points for a face that are output by the single-stage detection and identification model 150, and the head pose estimation module 510 determines a head pose, shown as the 6 DoF orientation 512. The head pose can be determined in any technically feasible manner in some embodiments, such as using a perspective-n-point algorithm. If multiple faces are detected by the single-stage detection and identification model 150, then the CV application 146 can select one of the faces for processing by the head pose estimation module 510. The face can be selected in any technically feasible manner in some embodiments, such as always selecting a face associated with a largest bounding box, selecting a face closest to a center of the downscaled image 506, selecting a face based on user input or some other criteria, or the like. Then, the head pose estimation module 510 can process the facial key points for the selected face to determine the 6 DoF orientation 512.

The normalization and eye patch extraction module 514 takes as input the image 502, the head pose (e.g., the 6 DoF orientation 516), and the facial key points, and the normalization and eye patch extraction module 514 generates a normalized image patch of the eye-region or face, shown as the normalized eye patch 516. In some embodiments, the normalization and eye patch extraction module 514 can (1) extract a region of the input image 502 around the eyes, and (2) perform a warp perspective technique that applies a perspective transformation to the extracted region to generate the normalized eye patch 516. In such cases, the warp perspective is used to correct for a rotation of the face based on the 6 DoF orientation 512 of the head pose so that a line that passes through the eyes is horizontal, as well as to scale the eye patch region to a standard size. In some embodiments, to reduce power consumption, the warp perspective can be quantized by quantizing (1) a mapping of the warp perspective that is used to transform the extracted region to the normalized eye patch 516, and (2) coordinates that are the pixel locations transformed from one perspective to another. In some embodiments, the warp perspective can also be executed on a hardware accelerator to improve performance. Although described herein primarily with respect to the normalized eye patch 516 as a reference example, in some embodiments, either normalized face or eye patches can be used. When a normalized face is used, the output of the normalization step can be a roll and scale-corrected whole face instead of only a smaller patch around the eyes, and the normalized face is then input into the gaze estimation model 152. In some cases, using the entire face may give more information and lead to higher accuracy but at the cost of more compute energy.

The gaze estimation model 152 is a machine learning model that is trained to take as input a normalized image of an eye region of the selected face (e.g., the normalized eye patch 516) or an entire normalized face region, and to output gaze angles that are represented by the gaze vector 520. In some embodiments, the gaze estimation model 152 can be implemented as a trained artificial neural network that includes a number of layers of neurons. For example, in some embodiments, the gaze estimation model 152 can be implemented as a neural network having the MobileViTv2 (Mobile Vision Transformer version 2) architecture, with a small set of layers to produce the final gaze angle outputs. In some embodiments, the gaze estimation model 152 can be augmented with a user-customized network for reducing the gaze angle error. In some embodiments, the user-customized network can be trained using images of the face(s) of specific user(s). In such cases, the user-customized network can be trained during a calibration phase in which the user is asked to look at specific points on a screen, and captured images of the user are used to train the user-customized network, as described in U.S. Pat. No. 11,593,661, entitled “Few-shot training of a neural network,” which is incorporated herein by reference in its entirety. In addition, multiple facial ID signatures and one or more user-customized networks can be stored for different users. In some embodiments, customized weights can be loaded ahead of when the gaze estimation model 152 is used, such as when the facial ID signature is determined, so as to hide latency.

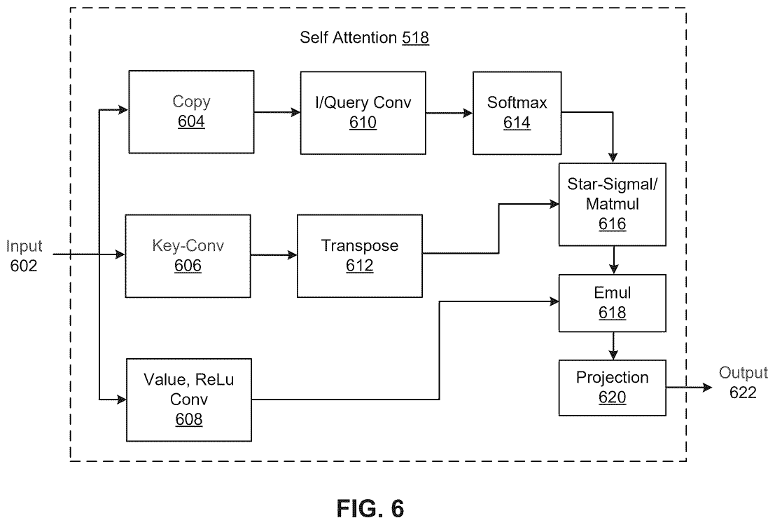

In some embodiments, similar to the single-stage detection and identification model 150, the gaze estimation model 152 can be optimized using hybrid 4-bit/8-bit per-vector scaled quantization, in which some layers of the gaze estimation model 152 are quantized using 8-bit quantization while other layers of the gaze estimation model 152 are quantized using 4-bit quantization. For example, early layers and depthwise convolution layers of the gaze estimation model 152 could be quantized using 8-bit quantization to maintain accuracy, while other layers of the gaze estimation model 152 could be quantized using 4-bit quantization to further reduce memory usage and save power. In some embodiments, some nonlinear layers can be quantized as well as linear layers. In some embodiments, complex activations in the gaze estimation model 152, such as SiLU activations, can be replaced with hardware-friendly nonlinear functions, such as ReLU activations. Illustratively, the gaze estimation model 152 includes the self-attention module 518, which can be optimized to better support the hybrid 4-bit/8-bit per-vector scaled quantization. In some embodiments, such as when the gaze estimation model 152 is a neural network having the MobileViTv2 architecture, the self-attention module 518 can include the layers described below in conjunction with FIG. 6.

The point of regard computation module 522 takes as input the gaze vector 520 indicating the gaze angles, the 6 DoF orientation 512 of the head pose, and the facial key points, based on which the point of regard computation module 522 computes a point of regard 524. The point of regard 524 is a point where the eye gaze meets the plane of a screen. The point of regard 524 can be computed in any technically feasible manner, including using known techniques, in some embodiments. For example, for a laptop display, the point of regard 524 can be computed as the point of intersection of the gaze's ray with the 2D plane in which the laptop screen is located in the camera coordinate system.

Once computed, the CV application 146 can use the point of regard 524 in any technically feasible manner in some embodiments. For example, in some embodiments, the point of regard 524 can be used for user presence detection, such as user presence detection that is used to wake up a computing device or screen thereof from a sleep mode and/or switch the computing device or the screen into the sleep mode when no user is looking at the screen. As another example, in some embodiments, the point of regard 524 can be used for gaze-aware gaming in which in-game assistance is provided based on the point of regard. As another example, the point of regard 524 can be used in a media consumption application, such as an application via which a user can watch media content and receive information about an actor or actress of focus. As a further example, in some embodiments, the point of regard 524 can be used for authenticating a user. As yet another example, in some embodiments, the point of regard 524 can be used for safety monitoring. Other example use cases include gaze-contingent foveated dimming of the backlight of a display to save power and gaze-contingent foveated rendering to reduce the computational cost of rendering.

FIG. 6 is a more detailed illustration of the self-attention module 518 of FIG. 5, according to various embodiments. As shown, the self-attention module 518 includes, without limitation, a key-convolution module 606; a value, ReLu convolution module 608; a I/query convolution module 610; a transpose module 612; a softmax module 614; a star-sigma/matrix multiplication module 616; an element-wise multiplication (EMUL) module 618; and a projection module 620. As described, the self-attention module 518 can be included in the gaze estimation model 152 when the gaze estimation model 152 is a neural network having, e.g., the MobileViTv2 architecture. In such cases, the self-attention module 518 can replace the multi-head self-attention in the conventional MobileViTv2 architecture. Experience has shown that the self-attention module 518 is particularly hardware friendly when executing on hardware accelerators that are designed for matrix multiplication.

The self-attention module 518 takes as input an output of previous layer(s) of the gaze estimation model 152. For example, in the case of MobileViTv2, the input 602 could include k d-dimensional token (or patch) embeddings. The input 602 and a copy 604 of the input are processed using the key-convolution module 606 and the value, ReLu convolution module 608 and the I/query convolution module 610, respectively. The key-convolution module 606, the value, ReLu convolution module 608, and the I/query convolution module 610 apply convolution operations to the inputs to generate key, value, and query vectors, respectively. Each convolution can be a learned filter. The separate convolutions all use the same input value. The convolution of the I/query convolution module 610 for the query is modified such that weights and activations are swapped in the convolution operation to be more efficient. The key vector acts as a reference point for comparison with the query vector to determine relevance, and the value vector includes the actual information to be retrieved and weighted based on the key-value similarity. The transpose module 612 transposes the key vector that is output by the key-convolution module 606. The softmax module 614 applies a softmax to the query vector that is output by the I/query convolution module 610. The star-sigma/matrix multiplication module 616 performs a matrix multiplication of the transposed key vector by the query vector to which the softmax has been applied. A common matrix multiplication is used to avoid some expand and accumulation operations. The EMUL module 618 performs an element-wise multiplication of the output of the star-sigma/matrix multiplication module 616 and the value vector that is output by the value, ReLu convolution module 608. The actual attention coefficients are computed by the star sigma and are applied to the values with the EMUL. The projection module 620 converts the output of the EMUL module 618 back to one or more tokens, shown as output 622, for a next layer of the gaze estimation model 152, and the output 622 can then be input into the next layer.

FIG. 7 is a flow diagram of method steps for training the single-stage detection and identification model 150 of FIG. 1, according to various embodiments. Although the method steps are described in conjunction with the systems of FIGS. 1-6, persons skilled in the art will understand that any system configured to perform the method steps in any order falls within the scope of the present embodiments.

As shown, a method 700 begins at step 702, where the model trainer 116 receives, as training data, images that include faces and associated labels. In some embodiments, the labels include bounding boxes around the faces, facial key points, and facial ID signatures associated with the faces.

At step 704, the model trainer 116 inputs an image from the received images into an untrained version of the single-stage detection and identification model 150 to generate face bounding box(es) and associated confidence score(s), facial key points, and signature(s) indicating identities of face(s) within the image. In some embodiments, the untrained version of the single-stage detection and identification model 150 can be a completely untrained model that includes randomized parameter values. Alternatively, in some embodiments, the untrained version of the single-stage detection and identification model 150 can be a pre-trained model that is being fine-tuned.

At step 706, the model trainer 116 computes a loss based on the face bounding box(es), the facial key points, and the signature(s) and the received labels. In some embodiments, the loss includes (1) a bounding box loss that is computed as a difference between the bounding box(es) output by the model being trained and the ground-truth bounding box(es) in the training data labels, (2) a classification loss that penalizes misidentifications of faces by the model, (3) an ID loss that is computed as a difference (e.g., a L1 or L2 distance) between the signature(s) output by the model and ground-truth signatures in the training data labels, and (4) an L2 loss between positions of the facial key points output by the model and ground truth facial key points.

At step 708, the model trainer 116 updates parameters of the single-stage detection and identification model 150 based on the loss. The model trainer 116 can update parameters of the single-stage detection and identification model 150 in any technically feasible manner in some embodiments. For example, in some embodiments, the model trainer 116 can update parameters of the single-stage detection and identification model 150 using a backpropagation technique with gradient descent or a variation thereof, until a stopping condition is met, such as training has been performed for a predefined number of iterations, the loss plateaus, or the like.

At step 710, if the model trainer 116 determines to continue training, then at step 712, the model trainer 116 selects another image from the received images to use for training. The method 700 then returns to step 704, where the model trainer 116 inputs the selected image into the single-stage detection and identification model 150 to generate face bounding box(es) and associated confidence score(s), key points, and signature(s) indicating identities of face(s) within the selected image. On the other hand, if the model trainer 116 determines to stop training (e.g., after training has been performed for a predefined number of iterations or the loss plateaus), then the method 700 ends.

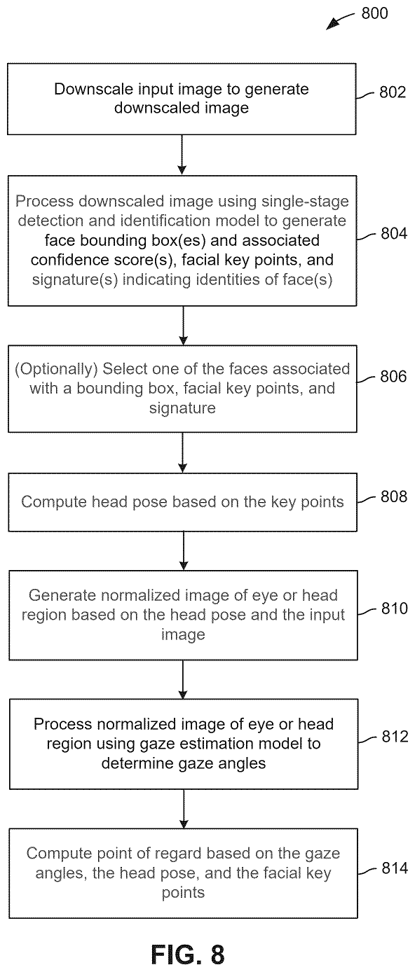

FIG. 8 is a flow diagram of method steps for determining a point of regard from an input image, according to various embodiments. Although the method steps are described in conjunction with the systems of FIGS. 1-6, persons skilled in the art will understand that any system configured to perform the method steps in any order falls within the scope of the present embodiments.

As shown, a method 800 begins at step 802, where the CV application 146 downscales an input image to generate a downscaled image. In some embodiments, the CV application 146 can receive as input the frames of a video captured by a camera, such as a camera that is mounted on a computing device, and process each of the received frames as an input image. In some embodiments, to minimize energy consumption, the input image can be generated by an ISP that performs a relatively minimal amount of processing on raw sensor data from a camera. The input image can be downscaled by any amount and in any technically feasible manner, including via known downscaling techniques, in some embodiments. In some embodiments, the amount of downscaling can be based on a desired accuracy of the point of regard that is being determined and/or an amount of available compute resources. For example, in some embodiments, the CV application 146 can scale the input image to a downscaled image that is 192×192 pixels. In some embodiments, the CV application 146 can also perform pre-processing to de-Bayer image data from the camera sensor and perform a gamma correction to create luma images that are in grayscale and a quantized format (e.g., 8 bit).

At step 804, the CV application 146 processes the downscaled image using the single-stage detection and identification model 150 to generate face bounding box(es) and associated confidence score(s), facial key points, and signature(s) indicating identities of face(s) within the downscaled image. In some embodiments, the single-stage detection and identification model 150 is a trained neural network that takes as input the downscaled image and outputs, for each face that is detected, a bounding box around the face and a confidence score indicating a confidence that the bounding box includes a face, a number (e.g., 5) of facial key points, and a facial ID signature that is a vector or array of numbers unique to a particular face. In order to operate with less power, in some embodiments, the single-stage detection and identification model 150 can be implemented as a neural network with a small architecture that includes relatively few weights, and the single-stage detection and identification model 150 can also be quantized using a hybrid per-vector scaled quantization, such as a hybrid 4-bit/8-bit quantization. For example, some layers of the single-stage detection and identification model 150, such as early layers and depthwise convolution layers, could be quantized using 8-bit quantization to maintain accuracy, while other layers of the single-stage detection and identification model 150 could be quantized using 4-bit quantization. As described, in some embodiments, the quantization performed can be a hybrid per-vector scaled quantization, in which vectors are quantized (reduced to a smaller set of possible values) while applying a scaling factor to each individual vector. In some embodiments, some nonlinear layers can be quantized as well as linear layers. In some embodiments, complex activations in the single-stage detection and identification model 150, such as SiLU activations, can be replaced with hardware-friendly nonlinear functions, such as ReLU activations. In some embodiments, the signature that is output by the single-stage detection and identification model 150 can be a vector or array having a relatively short length (e.g., 32 or 64), as opposed to conventional signatures that oftentimes have a length of 512. In some embodiments, the model trainer 116 can train the single-stage detection and identification model 150 according to the method 700 described above in conjunction with FIG. 7.

At step 806, the CV application 146 optionally selects one of the faces associated with a bounding box, facial key points, and signature. The signature is useful for customizing the gaze estimation model 152 for a face associated with the signature, so that more accurate points of regard can be determined. If multiple faces are detected by the single-stage detection and identification model 150, then the CV application 146 can select one of the faces for further processing. The face can be selected in any technically feasible manner in some embodiments, such as always selecting a face associated with a largest bounding box, selecting a face closest to a center of the downscaled image, selecting a face based on user input or some other criteria, or the like. In some embodiments, multiple faces can be selected and processed to determine associated eye gazes.

At step 808, the CV application 146 computes a head pose based on the key points associated with the selected face. The head pose can be computed in any technically feasible manner in some embodiments, such as using a perspective-n-point algorithm. In some embodiments, the head pose can be computed as a 6 DoF orientation (e.g., 6 DoF orientation 512).

At step 810, the CV application 146 generates a normalized image of an eye or face region based on the head pose and the input image. In some embodiments, the CV application 146 can (1) extract a region of the input image around the eyes or the entire face, and (2) perform a warp perspective technique that applies a perspective transformation to the extracted region to generate the normalized image of the eye or face region. In such cases, the warp perspective is used to correct for a rotation of the face based on the head pose so that a line that passes through the eyes is horizontal, as well as to scale the extracted region of the input image to a standard size. In some embodiments, to reduce power consumption, the warp perspective can be quantized by quantizing (1) a mapping of the warp perspective that is used to transform the extracted region of the input image to the normalized image of the eye or face region, and (2) coordinates that are the pixel locations transformed from one perspective to another. In some embodiments, the warp perspective can also be executed on a hardware accelerator to improve performance.

At step 812, the CV application 146 processes the normalized image of the eye or face region using the gaze estimation model 152 to determine gaze angles. As described, the gaze estimation model 152 is a machine learning model that is trained to take as input a normalized image of an eye or face region and to output gaze angles that are represented by, e.g., a gaze vector. For example, in some embodiments, the gaze estimation model 152 can be implemented as a neural network having the MobileViTv2 architecture, with a small set of layers to produce the final gaze angle outputs. In some embodiments, the gaze estimation model 152 can be augmented with a user-customized network, which is trained using images of the face(s) of specific user(s) having specific ID(s), in order to reduce the error of gaze angles output by the gaze estimation model 152. In particular, the gaze estimation model 152 can be augmented with a user-customized network for the particular face associated with the signature generated at step 804. As described, the user-customized network can be trained during a calibration phase in which the user is asked to look at specific points on a screen, and captured images of the user are used to train the user-customized network. In addition, multiple facial ID signatures and one or more user-customized networks can be stored for different users. In some embodiments, customized weights can be loaded ahead of when the gaze estimation model 152 is used, such as when the facial ID signature is determined, so as to hide latency. In some embodiments, similar to the single-stage detection and identification model 150, the gaze estimation model 152 can be optimized using hybrid per-vector scaled quantization. In some embodiments, some nonlinear layers can be quantized as well as linear layers. In some embodiments, complex activations in the gaze estimation model 152, such as SiLU activations, can be replaced with hardware-friendly nonlinear functions, such as ReLU activations. In some embodiments, the gaze estimation model 152 includes a self-attention module, such as the self-attention module 518 described above in conjunction with FIGS. 5-6, that is optimized to better support the hybrid per-vector scaled quantization.

At step 814, the CV application 146 computes a point of regard based on the gaze angles, the head pose, and the facial key points. As described, the point of regard is a point where the eye gaze meets the plane of a screen. The point of regard can be computed in any technically feasible manner, including using known techniques, in some embodiments. For example, for a laptop display, the point of regard can be computed as the point of intersection of the gaze's ray with the 2D plane in which the laptop screen is located in the camera coordinate system. Although described herein primarily with respect to point of regard as a reference example, in some embodiments, techniques disclosed herein can be applied for eye tracking more generally, such as to track the eye gaze of a user without computing a point of regard. Once computed, the CV application 146 can use the point of regard in any technically feasible manner in some embodiments. For example, in some embodiments, the point of regard can be used for user presence detection, such as user presence detection that is used to wake up a computing device or screen thereof from a sleep mode and/or switch the computing device or the screen into the sleep mode when no user is looking at the screen. As another example, in some embodiments, the point of regard can be used for gaze-aware gaming in which in-game assistance is provided based on the point of regard. As another example, the point of regard can be used in a media consumption application, such as an application via which a user can watch media content and receive information about an actor or actress of focus. As a further example, in some embodiments, the point of regard can be used for authenticating a user. As yet another example, in some embodiments, the point of regard can be used for safety monitoring. Other example use cases include gaze-contingent foveated dimming of the backlight of a display to save power and gaze-contingent foveated rendering to reduce the computational cost of rendering.

In sum, techniques are disclosed for always-on eye tracking. In some embodiments, a CV application receives as input an image, such as a frame of a video that is captured by a camera, and the CV application processes the input image to determine a point of regard, which is where an eye gaze meets the plane of a screen. First, the CV application downscales the input image to generate a downscaled image. The CV application processes the downscaled image using a trained single-stage detection and identification model to generate face bounding box(es) and associated confidence score(s), facial key points, and signature(s) indicating identities of face(s) within the downscaled image. The single-stage detection and identification model can be optimized using a hybrid per-vector scaled quantization based on the capabilities of the hardware and a target performance in terms of latency, accuracy, and/or energy. In addition, complex activations in the single-stage detection and identification model, such as SiLU activations, can be replaced with hardware-friendly nonlinear functions, such as ReLU activations. If the single-stage detection and identification model detects multiple faces, then the CV application selects one of the faces associated with a bounding box, facial key points, and signature to use. For the selected face, the CV application computes a head pose, using facial key points associated with the selected face. Then, the CV application generates a normalized image of an eye region of the selected face, or the entire face, based on the head pose, the facial key points, and the input image. In some embodiments, the normalized image of the eye or face region can be generated using a warp perspective that is quantized. The CV application processes the normalized image of the eye or face region using a trained gaze estimation model to determine gaze angles. Similar to the single-stage detection and identification model, the gaze estimation model can be optimized using a hybrid per-vector scaled quantization and/or complex activations in the gaze estimation model, such as SiLU activations, can be replaced with hardware-friendly nonlinear functions, such as ReLU activations. In some embodiments, the gaze estimation model includes a self-attention that is optimized to better support the hybrid per-vector scaled quantization. In some embodiments, the gaze estimation model is trained specifically for a user, using a calibration procedure to improve accuracy. The CV application computes a point of regard based on the gaze angles output by the gaze estimation model, the head pose, and the facial key points.

At least one technical advantage of the disclosed techniques relative to the prior art is that, with the disclosed techniques, an eye-tracking pipeline can be executed using significantly less computational resources and power than conventional eye-tracking pipelines require. The disclosed techniques can also compute a point of regard with relatively low latency and a relatively high frame rate of, for example, up to 120 Hz. In addition, the disclosed techniques can process input images that are captured by ordinary cameras, such as the integrated cameras that are built into laptop computers, as opposed to specialized cameras such as infrared cameras. These technical advantages represent one or more technological improvements over prior art approaches.
1. In some embodiments, a computer-implemented method for eye tracking comprises processing a first image using a first trained machine learning model that detects a face within the first image and predicts an identity of the face, determining at least one of an eye gaze or a point of regard based on the face and the identity of the face, and performing, via a computing device, at least one action based on the at least one of the eye gaze or the point of regard.
2. The computer-implemented method of clause 1, wherein one or more first layers of the first trained machine learning model are quantized using a first number of bits, wherein one or more second layers of the first trained machine learning model that follow the one or more first layers are quantized using a second number of bits, and wherein the first number of bits is greater than the second number of bits.
3. The computer-implemented method of clauses 1 or 2, wherein one or more depthwise convolution layers of the first trained machine learning model are quantized using a first number of bits, wherein one or more other layers of the first trained machine learning model are quantized using a second number of bits, and wherein the first number of bits is greater than the second number of bits.
4. The computer-implemented method of any of clauses 1-3, further comprising downscaling and quantizing a luma component of a second image that is captured by a camera to generate the first image.
5. The computer-implemented method of any of clauses 1-4, wherein the first trained machine learning model outputs a bounding box around the face, one or more key points associated with the face, and a signature representing the identity of the face.
6. The computer-implemented method of any of clauses 1-5, further comprising determining a head pose based on the one or more key points, generating, based on the first image and the head pose, a second image that includes a normalized eye or face region, processing the second image using a second trained machine learning model to detect the eye gaze, and computing the point of regard based on the eye gaze, the head pose, and the one or more key points.
7. The computer-implemented method of any of clauses 1-6, wherein the second trained machine learning model comprises one or more self-attention layers that use a common matrix multiplication.
8. The computer-implemented method of any of clauses 1-7, wherein the second trained machine learning model is customized based on the identity.
9. The computer-implemented method of any of clauses 1-8, wherein the at least one action comprises either waking up the computing device or a screen thereof from a sleep mode or switching the computing device or the screen into the sleep mode.
10.The computer-implemented method of any of clauses 1-9, wherein the at least one action is performed in a video game or media consumption application executing on the computing device.
11. In some embodiments, one or more non-transitory computer-readable storage media include instructions that, when executed by at least one processor, cause the at least one processor to perform steps for eye tracking, the steps comprising processing a first image using a first trained machine learning model that detects a face within the first image and predicts an identity of the face, determining at least one of an eye gaze or a point of regard based on the face and the identity of the face, and performing at least one action based on the at least one of the eye gaze or the point of regard.
12.The one or more non-transitory computer-readable storage media of clause 11, wherein one or more first layers of the first trained machine learning model are quantized using a first number of bits, wherein one or more second layers of the first trained machine learning model that follow the one or more first layers are quantized using a second number of bits, and wherein the first number of bits is greater than the second number of bits.
13.The one or more non-transitory computer-readable storage media of clauses 11 or 12, wherein one or more depthwise convolution layers of the first trained machine learning model are quantized using a first number of bits, wherein one or more other layers of the first trained machine learning model are quantized using a second number of bits, and wherein the first number of bits is greater than the second number of bits.
14.The one or more non-transitory computer-readable storage media of any of clauses 11-13, wherein the instructions, when executed by the at least one processor, further cause the at least one processor to perform the step of downscaling and quantizing a luma component of a second image that is captured by a camera to generate the first image.
15.The one or more non-transitory computer-readable storage media of any of clauses 11-14, wherein the first trained machine learning model outputs a bounding box around the face, one or more key points associated with the face, and a signature representing the identity of the face.
16.The one or more non-transitory computer-readable storage media of any of clauses 11-15, wherein the instructions, when executed by the at least one processor, further cause the at least one processor to perform the steps of determining a head pose based on the one or more key points, generating, based on the first image and the head pose, a second image that includes a normalized eye or face region, processing the second image using a second trained machine learning model to detect the eye gaze, and computing the point of regard based on the eye gaze, the head pose, and the one or more key points.
17.The one or more non-transitory computer-readable storage media of any of clauses 11-16, wherein processing the second image comprises performing a warp perspective transformation, and wherein the warp perspective transformation is quantized.
18.The one or more non-transitory computer-readable storage media of any of clauses 11-17, wherein the first trained machine learning model further outputs a confidence score associated with the bounding box.
19.The one or more non-transitory computer-readable storage media of any of clauses 11-18, wherein the first trained machine learning model detects a plurality of faces, and the instructions, when executed by the at least one processor, further cause the at least one processor to perform the step of selecting the face from the plurality of faces.
20. In some embodiments, a system comprises one or more memories storing instructions, and one or more processors that are coupled to the one or more memories and, when executing the instructions, are configured to process an image using a trained machine learning model that detects a face within the image and predicts an identity of the face, determine at least one of an eye gaze or a point of regard based on the face and the identity of the face, and perform at least one action based on the at least one of the eye gaze or the point of regard.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for eye tracking, the method comprising:
processing a first image using a first trained machine learning model that detects a face within the first image and predicts an identity of the face;
determining at least one of an eye gaze or a point of regard based on the face and the identity of the face; and
performing, via a computing device, at least one action based on the at least one of the eye gaze or the point of regard.

2. The computer-implemented method of claim 1, wherein one or more first layers of the first trained machine learning model are quantized using a first number of bits, wherein one or more second layers of the first trained machine learning model that follow the one or more first layers are quantized using a second number of bits, and wherein the first number of bits is greater than the second number of bits.

3. The computer-implemented method of claim 1, wherein one or more depthwise convolution layers of the first trained machine learning model are quantized using a first number of bits, wherein one or more other layers of the first trained machine learning model are quantized using a second number of bits, and wherein the first number of bits is greater than the second number of bits.

4. The computer-implemented method of claim 1, further comprising downscaling and quantizing a luma component of a second image that is captured by a camera to generate the first image.

5. The computer-implemented method of claim 1, wherein the first trained machine learning model outputs a bounding box around the face, one or more key points associated with the face, and a signature representing the identity of the face.

6. The computer-implemented method of claim 5, further comprising:
determining a head pose based on the one or more key points;
generating, based on the first image and the head pose, a second image that includes a normalized eye or face region;
processing the second image using a second trained machine learning model to detect the eye gaze; and
computing the point of regard based on the eye gaze, the head pose, and the one or more key points.

7. The computer-implemented method of claim 6, wherein the second trained machine learning model comprises one or more self-attention layers that use a common matrix multiplication.

8. The computer-implemented method of claim 6, wherein the second trained machine learning model is customized based on the identity.

9. The computer-implemented method of claim 1, wherein the at least one action comprises either waking up the computing device or a screen thereof from a sleep mode or switching the computing device or the screen into the sleep mode.

10. The computer-implemented method of claim 1, wherein the at least one action is performed in a video game or media consumption application executing on the computing device.

11. One or more non-transitory computer-readable storage media including instructions that, when executed by at least one processor, cause the at least one processor to perform steps for eye tracking, the steps comprising:
processing a first image using a first trained machine learning model that detects a face within the first image and predicts an identity of the face;
determining at least one of an eye gaze or a point of regard based on the face and the identity of the face; and
performing at least one action based on the at least one of the eye gaze or the point of regard.

12. The one or more non-transitory computer-readable storage media of claim 11, wherein one or more first layers of the first trained machine learning model are quantized using a first number of bits, wherein one or more second layers of the first trained machine learning model that follow the one or more first layers are quantized using a second number of bits, and wherein the first number of bits is greater than the second number of bits.

13. The one or more non-transitory computer-readable storage media of claim 11, wherein one or more depthwise convolution layers of the first trained machine learning model are quantized using a first number of bits, wherein one or more other layers of the first trained machine learning model are quantized using a second number of bits, and wherein the first number of bits is greater than the second number of bits.

14. The one or more non-transitory computer-readable storage media of claim 11, wherein the instructions, when executed by the at least one processor, further cause the at least one processor to perform the step of downscaling and quantizing a luma component of a second image that is captured by a camera to generate the first image.

15. The one or more non-transitory computer-readable storage media of claim 11, wherein the first trained machine learning model outputs a bounding box around the face, one or more key points associated with the face, and a signature representing the identity of the face.

16. The one or more non-transitory computer-readable storage media of claim 15, wherein the instructions, when executed by the at least one processor, further cause the at least one processor to perform the steps of:
determining a head pose based on the one or more key points;
generating, based on the first image and the head pose, a second image that includes a normalized eye or face region;
processing the second image using a second trained machine learning model to detect the eye gaze; and
computing the point of regard based on the eye gaze, the head pose, and the one or more key points.

17. The one or more non-transitory computer-readable storage media of claim 16, wherein processing the second image comprises performing a warp perspective transformation, and wherein the warp perspective transformation is quantized.

18. The one or more non-transitory computer-readable storage media of claim 15, wherein the first trained machine learning model further outputs a confidence score associated with the bounding box.

19. The one or more non-transitory computer-readable storage media of claim 15, wherein the first trained machine learning model detects a plurality of faces, and the instructions, when executed by the at least one processor, further cause the at least one processor to perform the step of selecting the face from the plurality of faces.

20. A system, comprising:
one or more memories storing instructions; and
one or more processors that are coupled to the one or more memories and, when executing the instructions, are configured to:
process an image using a trained machine learning model that detects a face within the image and predicts an identity of the face,
determine at least one of an eye gaze or a point of regard based on the face and the identity of the face, and
perform at least one action based on the at least one of the eye gaze or the point of regard.
